(19) United States
(12) Patent Application Publication
(10) Pub. No.: US 2026/0371351 A1
(43) Pub. Date: Nov. 19, 2026

(54) ENHANCED UPLINK CONFIGURED GRANT

(71) Applicant: QUALCOMM Incorporated, San Diego, CA (US)

(72) Inventors: Qing LI, Princeton Junction, NJ (US); Junyi LI, Greentown, PA (US)

(21) Appl. No.: 19/675,139

(22) Filed: May 12, 2026

Related U.S. Application Data
(60) Provisional application No. 63/806,507, filed on May 15, 2025.

(51) Int. Cl. H04W 72/21; H04W 28/02

(52) U.S. Cl. CPC H04W 72/21; H04W 28/0278

(57) ABSTRACT

A user equipment (UE) may receive control signaling that indicates a resource configuration that identifies a plurality of resource allocations for the UE for uplink transmission. The UE may transmit, within a time duration corresponding to a first resource allocation of the plurality of resource allocations, a resource usage indication that indicates an intent to use the first resource allocation or to extend the first resource allocation. The UE may transmit, via the first resource allocation or an extended first resource allocation, one or more uplink messages in accordance with the resource usage indication.

### CROSS REFERENCES

The present Application for Patent claims benefit of U.S. Provisional Patent Application No. 63/806,507 by LI et al., entitled “ENHANCED UPLINK CONFIGURED GRANT,” filed May 15, 2025, assigned to the assignee hereof, and expressly incorporated herein.

### TECHNICAL FIELD

This disclosure relates generally to wireless communication, and more specifically to systems, devices, methods, and techniques associated with enhanced uplink configured grants.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

In wireless communications, configured grants may be used. However, some approaches involving configured grants may be improved.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a UE is described. The method may include receiving control signaling that indicates a resource configuration that identifies a set of multiple resource allocations for the UE for uplink transmission, transmitting, within a time duration corresponding to a first resource allocation of the set of multiple resource allocations, a resource usage indication that indicates an intent to use the first resource allocation or to extend the first resource allocation, and transmitting, via the first resource allocation or an extended first resource allocation, one or more uplink messages in accordance with the resource usage indication.

A UE for wireless communications is described. The UE may include a processing system that includes processor circuitry and memory circuitry that stores code. The processing system may be configured to cause the UE to receive control signaling that indicates a resource configuration that identifies a set of multiple resource allocations for the UE for uplink transmission, transmit, within a time duration corresponding to a first resource allocation of the set of multiple resource allocations, a resource usage indication that indicates an intent to use the first resource allocation or to extend the first resource allocation, and transmit, via the first resource allocation or an extended first resource allocation, one or more uplink messages in accordance with the resource usage indication.

Another UE for wireless communications is described. The UE may include means for receiving control signaling that indicates a resource configuration that identifies a set of multiple resource allocations for the UE for uplink transmission, means for transmitting, within a time duration corresponding to a first resource allocation of the set of multiple resource allocations, a resource usage indication that indicates an intent to use the first resource allocation or to extend the first resource allocation, and means for transmitting, via the first resource allocation or an extended first resource allocation, one or more uplink messages in accordance with the resource usage indication.

A non-transitory computer-readable medium storing code for wireless communications is described. The code may include instructions executable by one or more processors to receive control signaling that indicates a resource configuration that identifies a set of multiple resource allocations for the UE for uplink transmission, transmit, within a time duration corresponding to a first resource allocation of the set of multiple resource allocations, a resource usage indication that indicates an intent to use the first resource allocation or to extend the first resource allocation, and transmit, via the first resource allocation or an extended first resource allocation, one or more uplink messages in accordance with the resource usage indication.

In some examples of the method, user equipment (UEs), and non-transitory computer-readable medium described herein, transmitting the resource usage indication may include operations, features, means, or instructions for transmitting an activation indication within an activation window of the time duration, where the activation indication indicates the intent to use the first resource allocation to transmit the one or more uplink messages.

In some examples of the method, user equipment (UEs), and non-transitory computer-readable medium described herein, transmitting the resource usage indication may include operations, features, means, or instructions for transmitting an extension indication before an extension deadline located within the time duration corresponding to the first resource allocation, where the extension indication indicates that the first resource allocation may be extended, in accordance with an extension duration, beyond an end of the time duration of the first resource allocation.

Some examples of the method, user equipment (UEs), and non-transitory computer-readable medium described herein may further include operations, features, means, or instructions for transmitting a deactivation indication corresponding to the set of multiple resource allocations, where the deactivation indication indicates that the UE intends not to use one or more second resource allocations of the set of multiple resource allocations or a remaining portion of the first resource allocation after transmission of the deactivation indication.

A method for wireless communications by a network entity is described. The method may include transmitting control signaling that indicates a resource configuration that identifies a set of multiple resource allocations for a UE for uplink transmission, receiving, within a time duration corresponding to a first resource allocation of the set of multiple resource allocations, a resource usage indication that indicates an intent to use the first resource allocation or to extend the first resource allocation, and receiving, via the first resource allocation or an extended first resource allocation, one or more uplink messages in accordance with the resource usage indication.

A network entity for wireless communications is described. The network entity may include a processing system that includes processor circuitry and memory circuitry that stores code. The processing system may be configured to cause the network entity to transmit control signaling that indicates a resource configuration that identifies a set of multiple resource allocations for a UE for uplink transmission, receive, within a time duration corresponding to a first resource allocation of the set of multiple resource allocations, a resource usage indication that indicates an intent to use the first resource allocation or to extend the first resource allocation, and receive, via the first resource allocation or an extended first resource allocation, one or more uplink messages in accordance with the resource usage indication.

Another network entity for wireless communications is described. The network entity may include means for transmitting control signaling that indicates a resource configuration that identifies a set of multiple resource allocations for a UE for uplink transmission, means for receiving, within a time duration corresponding to a first resource allocation of the set of multiple resource allocations, a resource usage indication that indicates an intent to use the first resource allocation or to extend the first resource allocation, and means for receiving, via the first resource allocation or an extended first resource allocation, one or more uplink messages in accordance with the resource usage indication.

A non-transitory computer-readable medium storing code for wireless communications is described. The code may include instructions executable by one or more processors to transmit control signaling that indicates a resource configuration that identifies a set of multiple resource allocations for a UE for uplink transmission, receive, within a time duration corresponding to a first resource allocation of the set of multiple resource allocations, a resource usage indication that indicates an intent to use the first resource allocation or to extend the first resource allocation, and receive, via the first resource allocation or an extended first resource allocation, one or more uplink messages in accordance with the resource usage indication.

In some examples of the method, network entities, and non-transitory computer-readable medium described herein, receiving the resource usage indication may include operations, features, means, or instructions for receiving an activation indication within an activation window of the time duration, where the activation indication indicates the intent to use the first resource allocation to transmit the one or more uplink messages.

In some examples of the method, network entities, and non-transitory computer-readable medium described herein, receiving the resource usage indication may include operations, features, means, or instructions for receiving an extension indication before an extension deadline located within the time duration corresponding to the first resource allocation, where the extension indication indicates that the first resource allocation may be extended, in accordance with an extension duration, beyond an end of the time duration of the first resource allocation.

Some examples of the method, network entities, and non-transitory computer-readable medium described herein may further include operations, features, means, or instructions for receiving a deactivation indication corresponding to the set of multiple resource allocations, where the deactivation indication indicates that the UE intends not to use one or more second resource allocations of the set of multiple resource allocations or a remaining portion of the first resource allocation after transmission of the deactivation indication.

### BRIEF DESCRIPTION OF THE DRAWINGS

FIG. 1 shows an example of a wireless communication system.

FIG. 2 shows an example of an activation scheme that supports enhanced uplink configured grants.

FIG. 3 shows an example of an extension scheme that supports enhanced uplink configured grants.

FIG. 4 shows an example of a deactivation scheme that supports enhanced uplink configured grants.

FIG. 5 shows an example of a process flow that supports enhanced uplink configured grants.

FIG. 6 shows a block diagram of a processing system that supports enhanced uplink configured grants.

FIG. 7 shows a diagram of a system including a device that supports enhanced uplink configured grants.

FIG. 8 shows a block diagram of a processing system that supports enhanced uplink configured grants.

FIG. 9 shows a diagram of a system including a device that supports enhanced uplink configured grants.

FIGS. 10 and 11 show flowcharts illustrating methods that support enhanced uplink configured grants.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a network entity may provide configured grants to a user equipment (UE) to make periodic resources available for use by the UE. However, in some cases, the UE may have data to transmit at times that fall outside of the periodic resources. In such cases, a UE may wait until the next configured resource, increasing latency in communication operations. In some examples, a UE may request a reduced period or other configuration to transmit data more often. However, such modifications may lead to reduced overall resource utilization in a communications system. As such, an inherent conflict between resource utilization and latency is present in other approaches to configured grant communications. Such problems may be worse in cases of “bursty” traffic that involves bursts of communication. Further, such tensions between resource utilization and latency become more troublesome in light of latency and data rate considerations for emerging wireless communications protocols.

Aspects of the subject matter described in this disclosure relate to techniques for configured grant operations. For example, a UE may receive an indication of configured resources, sometimes referred to herein as pre-grants, which are made available to the UE, but may be activated by the UE before being used for communications. For example, given a set of periodic resources, the UE may transmit an activation indication to the network entity to activate a pre-grant resource, after which the UE may communicate with the network entity. In some examples (such as those involving bursty traffic) it may be desirable for the UE to continue transmitting beyond the initial pre-grant resources. In such cases, the UE may transmit an extension indication to the network entity to extend an activated grant for a period of time. In some examples, the UE may transmit a deactivation indication to deactivate a remaining portion of activated resources (e.g., corresponding to the original pre-grant, an extension thereof, or both). Further, all of the techniques described herein (e.g., activation, extension, and deactivation) may also be applicable to multiple configured grant configurations (e.g., involving different periods). For example, the UE 115-a may select one or more of the configurations to use for communications, and may apply activation, extension, and deactivation techniques in accordance with the descriptions herein.

Particular aspects of the subject matter described in this disclosure can be implemented to realize one or more of the following potential advantages. In some examples, by transmitting an activation indication, the described techniques can be used to improve resource utilization by utilizing resources activated by the UE for UE communications while keeping other resources available (e.g., not activated) for other devices or communications, while addressing latency considerations, as the UE can activate resources for communication without additional delays present in other techniques. In some examples, by transmitting an extension indication, the described techniques can be used to address latency considerations (e.g., latency for a burst of traffic), as the UE can extend resources for communication without additional delays present in other techniques, while also improving resource utilization by keeping other resources available for other devices or communications. In some examples, by transmitting deactivation indications, the described techniques can be used to improve resource utilization by releasing resources that were previously activated or extended by the UE, allowing other devices or communications to utilize such resources.

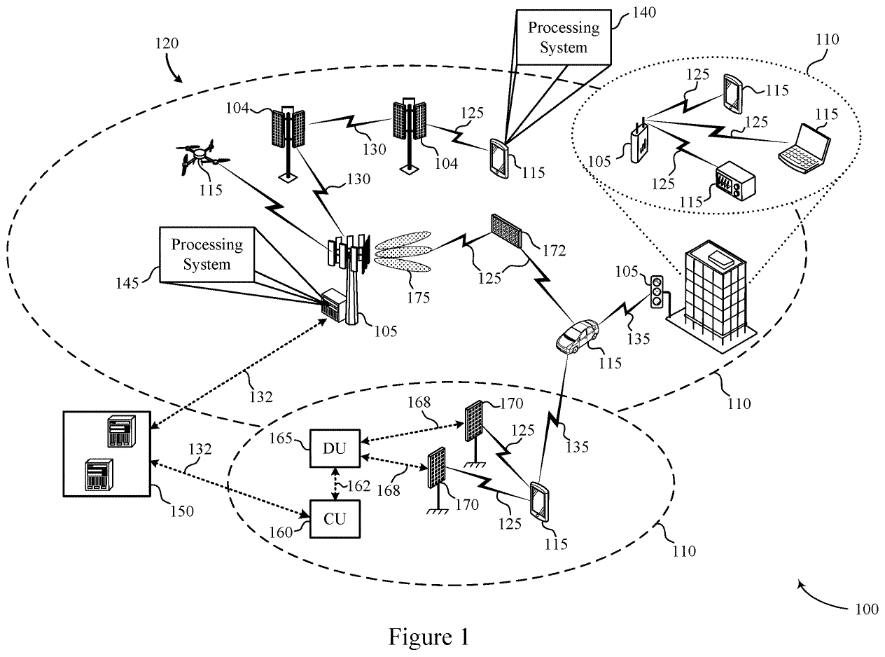

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active uplink BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for enhanced uplink configured grants. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support reduced latency and improved resource utilization, as the UE 115 may activate or extend resources to accommodate low-latency communications (e.g., while leaving other resources open for other devices or communications) and may further deactivate portions of previously-activated or previously-extended resources to be made available for other devices or communications.

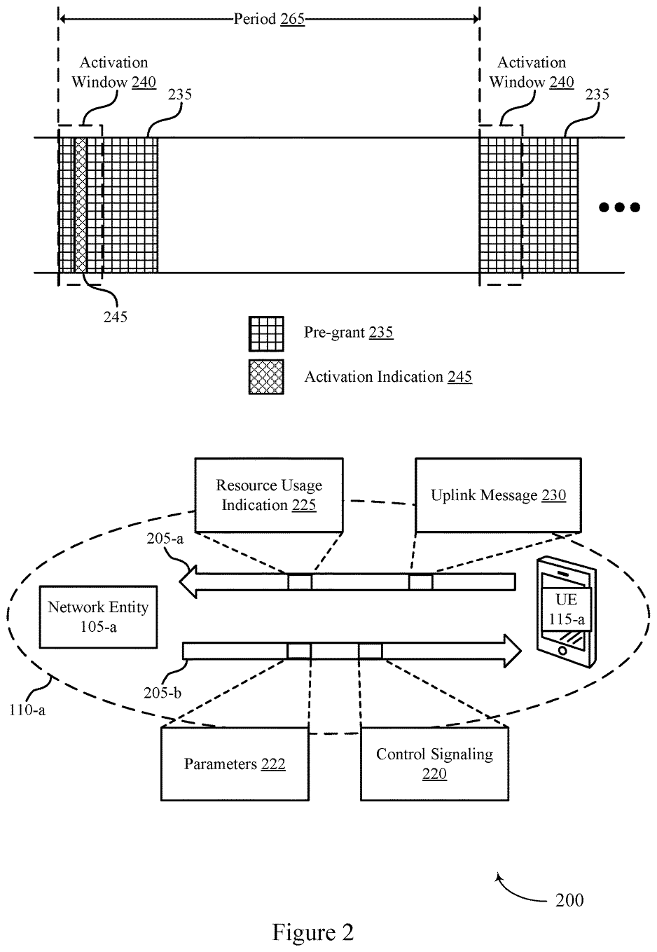

FIG. 2 shows an example of an activation scheme 200 that supports enhanced uplink configured grants. The activation scheme 200 may include the network entity 105-a, which may be an example of one or more network entities discussed in relation to other figures. The activation scheme 200 may include the UE 115-a, which may be an example of UEs discussed in relation to other figures. In some examples, the UE 115-a may be located in a geographic coverage area 110-a that may be associated with the network entity 105-a. The network entity 105-a and UE 115-a may communicate via one or more downlink communication links 205-a and one or more uplink communication links 205-b.

In some wireless communications systems, synergized UE to network to cloud operations may be desirable. To support such operations, uplink data rate and packet delay budget (PDB) considerations may be relevant. For example, rendering task offloading operations may involve a high uplink data rate to achieve higher service availability (e.g., considering the metadata to be uploaded for the rendering task is usually large and may involve latency considerations, such as 5 Mbits and 50 ms, 150 Mbits and 1.5 s, or other considerations).

Additionally, or alternatively, uplink metadata bursts for rendering task offloading may arrive in less-predictable ways, and latency considerations may involve the whole data burst (e.g., the metadata of the task) rather than an individual packet. In some examples, for the burst data carrying the metadata for rendering tasks, it may be desirable to address latency and data rate considerations for a whole data set rather than a specific packet.

In some examples, dynamic grant based on a Buffer Status Report (BSR), Delay Status Report (DSR), and/or SR may involve delays from BSR/DSR or SR to an uplink transmission occasion dynamically indicated by an uplink grant in DCI, which may not be able to address more stringent latency considerations for uplink transmissions (e.g., in 1-2 ms).

In some examples, a configured grant for uplink transmissions may reduce the delay from BSR/DSR or SR to an uplink transmission occasion, but may not be efficient with resource utilization (e.g., uplink metadata bursts for a rendering task offloading may arrive in a random way and some of the configured grant resources may not be used) and thus may not address desired spectral efficiency considerations.

Further, for supporting UE-Network-Cloud synergized operation, it may be desirable for a UE to address latency considerations for the whole data burst rather than an individual packet. For example, for a burst of uplink transmissions, the UE may wait for SR based dynamic uplink grants or may wait for the transmission occasions within a next configured grant period, which may not address the total latency considerations for the whole uplink data burst transmissions.

In some examples, uplink configured grants are employed to reduce control signaling overhead (e.g., for small data transmissions) or latency (e.g., comparing with schedule request (SR)-based dynamic grants). In some examples, a UE may be configured with multiple configured grant configurations (e.g., represented by a parameter such as Configurationᵢ or Configurationⱼ) with dedicated resource allocations (e.g., a quantity of contiguous slots (e.g., represented by a parameter such as Num_of_Slotsᵢ or Num_of Slotsⱼ respectively for Configurationᵢ or Configurationⱼ) within a period, such as the period 265 (e.g., represented by a parameter such as Periodicityᵢ or Periodicityⱼ respectively for Configurationᵢ or Configurationⱼ) for a configuration) within one uplink BWP.

For example, one configured grant configuration may indicate the arrangement of resource allocations (e.g., the pre-grants 235) and corresponding activation windows 240 in accordance with a period. However, the UE may also be configured with one or more other configurations, that may indicate one or more other arrangements of resource allocations (e.g., pre-grants) with corresponding activation windows (e.g., in according with one or more other periodicities). For example, another configuration may arrange resource allocations (e.g., the pre-grants) to avoid overlapping in time with resource allocations (e.g., pre-grants) of one or more other configurations, thereby providing options for the UE 115-a to communicate at different intervals.

As such, the techniques described herein may be employed for communications systems. Such an example communications system may include, for example discussions and techniques, the UE 115-a and the network entity 105-a.

For example, the UE 115-a may receive control signaling (e.g., the control signaling 220) that may indicate a resource configuration that identifies a plurality of resource allocations for the UE for uplink transmission. Such resource allocations may be referred to as pre-grants or reserved grants, such as the pre-grants 235. The pre-grants 235 may be arranged according to a period, such as the period 265, such that the pre-grants 235 may be scheduled in time periodically according to the period 265. In each period 265, one or more resource allocations (e.g., pre-grants 235) may be employed. In some examples, the network entity 105-a may transmit an indication of the period 265 or multiple such periods 265 (e.g., alongside or corresponding to other information described herein, such as the control signaling 220).

In some examples, multiple periods may be used. For example, the UE 115-a may be configured with multiple sets of pre-grants 235 (e.g., multiple configured grant configurations) that may each be associated with a period 265. In each

The UE 115-a may transmit (e.g., within a time duration corresponding to a first resource allocation of the plurality of resource allocations, such as a first pre-grant 235) a resource usage indication 225 (e.g., the Activation Indication 245) that indicates a usage or intent to use one or more pre-grants, such as an intent to use the first resource allocation (e.g., pre-grant 235) (or, as described elsewhere herein) to extend the first resource allocation (e.g., pre-grant 235). The UE 115-a may transmit the uplink message 230 or multiple such messages (which may be repetitions or may include unique uplink data) in accordance with the resource usage indication 225 (e.g., the Activation Indication 245).

In some examples, the UE 115-a may be configured initially with multiple pre-grants or reserved grants from a message (e.g., Msg 4 as the control signaling 220) during a random access procedure (e.g., for RRC connection), which may be based on an indication in another message (e.g., Msg3) for RRC Connect/Reconnect/Resume. In some examples, the UE 115-a may be configured with multiple pre-grants or reserved grants after the random access procedure for RRC connection (e.g., RRC reconfiguration as the control signaling 220). However, in some examples, and before being used for communications, such pre-grants 235 may be activated with an activation indication 245 transmission during an activation window 240. The activation window 240 may be within a time duration associated with a pre-grants 235, for example, the activation window 240 may start from the start of the time duration associated with the pre-grants 235. During the activation window 240, the UE 115-a may transmit the activation indication 245.

In some examples, the UE 115-a may select and activate one or more of the pre-grants 235 (e.g., the earliest available pre-grant 235, one or more pre-grants 235, for a quantity of physical resource blocks (PRBs), or in accordance with other parameters or elements) respectively within one or more activation windows 240 (e.g., by transmitting one or more activation indications 245 respectively within the one or more activation windows 240). The UE 115-a may select and activate one or more of the pre-grants 235 (e.g., the earliest available pre-grant 235, one or more pre-grants 235, for a quantity of physical resource blocks (PRBs), or in accordance with other parameters or elements) within one activation window 240 (e.g., by transmitting one activation indication 245 within the earliest window 240, where the one activation indication 245 may include or indicate a quantity of pre-grants 235 to be activated).

In some examples, the activation indication 245 may be or may include one or more uplink data transmissions (e.g., over a shared channel, such as a PUSCH), one or more uplink control messages (e.g., over a control channel, such as a PUCCH, or a shared channel, such as a PUSCH), or another uplink signal transmission (e.g., SR or SRS). In some examples, an activated pre-grant 235 may be referred to as a grant.

In the case that no activation indication 245 is received in a given activation window 240, then the pre-grant 235 within which the activation window 240 is located may be considered to not be activated by the UE 115-a, and the pre-grant 235 may be available for use or allocation (e.g., by network node for one or more other UEs).

In some examples, the activation window 240 (e.g., as a duration of x slots at the beginning of a pre-grant 235) may be configured (e.g., RRC configuration or RRC reconfiguration), activated (e.g., MAC CE activates one of the configured values), indicated (e.g., DCI indicates one of the configured or activated values, or defined. In some examples, one or more parameters of the activation window 240 may be transmitted by the network entity 105-a to the UE 115-a, and may be included in the parameters 222. In some examples, the parameters 222 may also be transmitted with, or otherwise indicated by, the control signaling 220 (e.g., together with the resource configuration (e.g., RRC) or activation (e.g., MAC CE) for UL transmissions).

In some examples, a timer may be used to measure the time for an activated pre-grant 235. For example, the UE 115-a, the network entity 105-a, or both, may start an active grant timer after the activation window and, in some examples, the timer may be used for synchronizing the active state of the pre-grant 235 between the UE 115-a and the network entity 105-a.

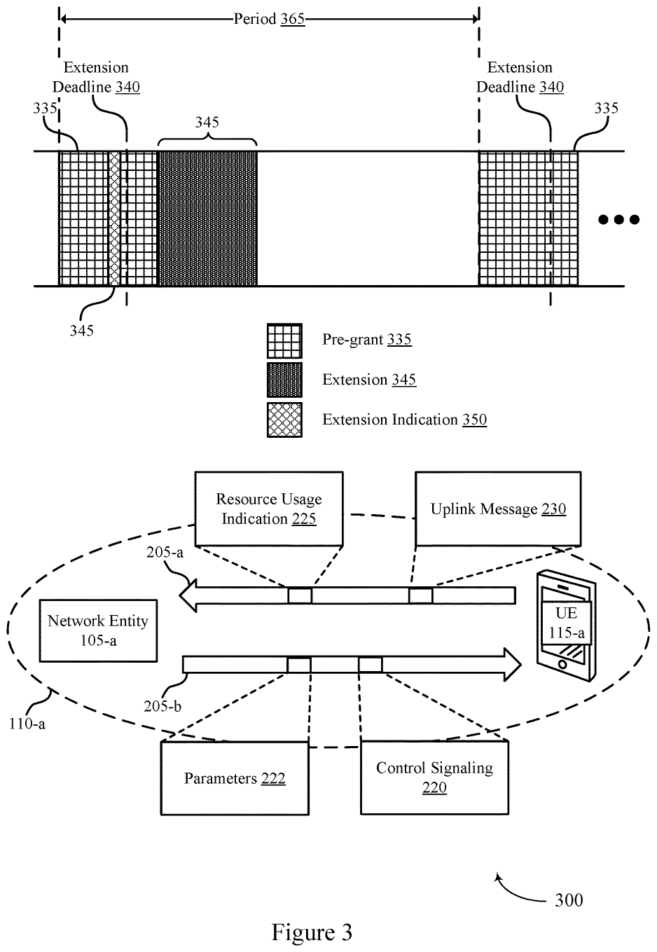

FIG. 3 shows an example of an extension scheme 300 that supports enhanced uplink configured grants. The extension scheme 300 may include the use of one or more resource allocations (e.g., pre-grants 335) for communications. The pre-grants 335 may be arranged according to a period, such as the period 365.

In some examples, the UE 115-a may extend (e.g., by transmitting an extension indication 350) an activated grant's active state with an extension (e.g., the extension 345 and, optionally, using a grant extension timer) prior to an extension timeline or deadline, such as the extension deadline 340. For example, the UE 115-a may transmit (e.g., within a time duration corresponding to a first resource allocation of the plurality of resource allocations, such as a first pre-grant 335) a resource usage indication 225 that indicates a usage or intent to use one or more pre-grants, such as an intent to extend the first resource allocation (e.g., pre-grant 235) in accordance with an extension, such as the extension 345. The UE 115-a may transmit the uplink message 230 or multiple such messages (which may be repetitions or may include unique uplink data) in accordance with the resource usage indication 225. Such an extension 345 may be employed for continuing an uplink transmission burst (e.g., without stopping uplink transmissions being made in the pre-grant 335 or elsewhere) to obtain usage of additional uplink resources. In some examples, in response to the extension indication 350, the UE 115-a the network entity 105-a, or both, may start an extension timer or extend a duration of another timer (e.g., an active grant timer) while the active grant timer is still running (e.g., before reaching the end of an activated pre-grant 335).

In some examples, the extension indication 350 may include an uplink transmission status transmission (e.g., any retransmission of a prior transmission) that is performed prior to the extension deadline 340. In some examples, such an extension indication 350 may be considered to be an implicit request for extension. In this case, the duration of the extension 345 may be configured (e.g., via RRC) or activated (e.g., via MAC CE) or indicated (e.g., via DCI).

In some examples, the extension indication 350 may include a BSR, or DSR, or both, that is transmitted prior to the extension deadline 340. In some examples, such an extension indication 350 may be considered to be an implicit request for extension UE's explicit request prior to the extension timeline. In this case, the duration of the extension 345 may be configured (e.g., via RRC) or activated (e.g., via MAC CE) or indicated (e.g., via DCI).

In some examples, the extension indication 350 may be an explicit request made by the UE 115-a to the network entity 105-a (e.g., dedicated signaling or a dedicated indication) to request extension of an activated pre-grant 335. In this case, the duration of the extension 345 may be included or indicated in the explicit request.

In some examples, the grant extension timers may be started respectively at the UE 115-a, the network entity 105-a, or both (e.g., after or in response to an expiration of the extension deadline 340, whether an implicit or explicit extension indication 350 is used), so that the network entity 105-a may refrain from utilizing (or scheduling) resources impacted by the extension 345 for other UEs or for other purposes.

In some examples, the network entity 105-a may transmit (e.g., in the parameters 222) an indication of the extension deadline 340 (e.g., a location in time, be it relative to the start or end of pre-grant 335 or relative to another point in time, or an absolute time indication, based on the time needed for the network entity 105-a to determine the resource allocation within the extension 345), an indication of the duration of the extension 345, which may correspond to a value of the grant extension timer. In some examples, such parameters 222 may be configured, activated, or indicated by the network entity 105-a. In some examples, the parameters 222 may also be transmitted with, or indicated by, the control signaling 220 (e.g., together with the resource configuration (e.g., RRC) or activation (e.g., MAC CE) for UL transmissions).

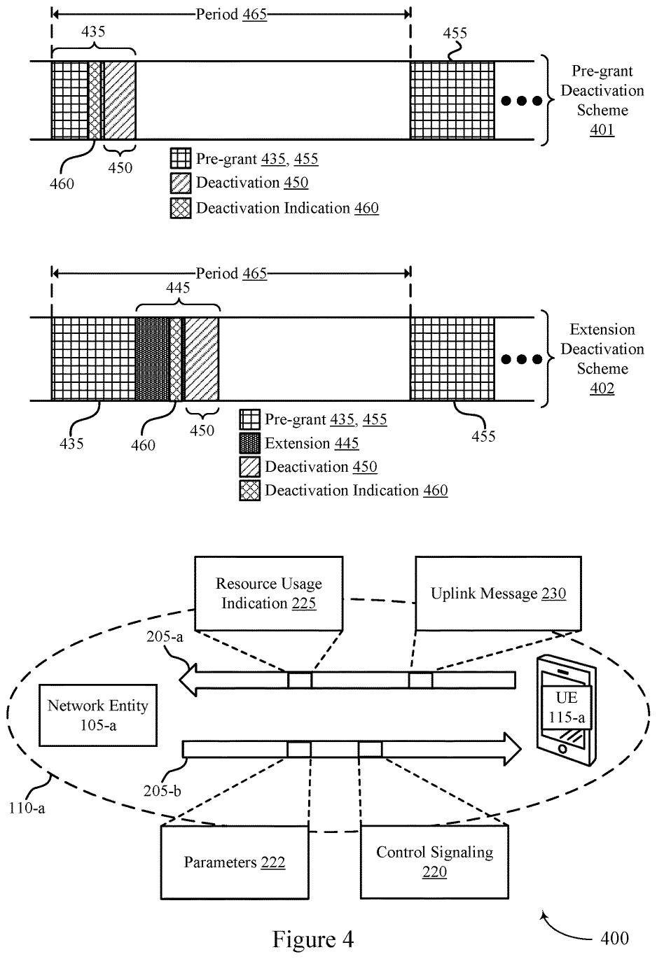

FIG. 4 shows an example of a deactivation scheme 400 that supports enhanced uplink configured grants. The deactivation scheme 400 may consider deactivation of one or more pre-grants 435 (e.g., arranged in accordance with the period 465), such as in the pre-grant deactivation scheme 401, deactivation of an extension, such as in the extension deactivation scheme 402, or both.

In some examples, the UE 115-a may deactivate one or more activated grants (e.g., a pre-grant 435 that has been activated (e.g., by the activation indication 245 as described in FIG. 2) or extended grant with the extension 445 (e.g., by the extension indication 350 as described in FIG. 3)) at any time within an active duration (e.g., be it the pre-grant 435 or an extension thereto, such as the extension 445). For example, the UE 115-a may transmit (e.g., within a time duration corresponding to a first resource allocation of the plurality of resource allocations, such as a first pre-grant 435) a resource usage indication 225 (e.g., deactivation indication 460) that indicates a usage or intent, such as an intent to deactivate a remaining portion of a resource allocation (e.g., pre-grant 435, the extension 445, or both). The UE 115-a may not transmit the uplink message 230 or multiple such messages (which may be repetitions or may include unique uplink data) in accordance with the resource usage indication 225 (e.g., no more UL transmissions after the deactivation indication 460). Further, the UE 115-a may deactivate a portion of a resource allocation (e.g., a pre-grant 435), an extension (e.g., the extension 445) of such a resource allocation, or both. For example, in the pre-grant deactivation scheme 401, the UE 115-a may deactivate the remaining resource allocation corresponding to the deactivation 450 of the pre-grant 435. Further, in the extension deactivation scheme 402, the UE 115-a may deactivate the remaining resource extension corresponding to the deactivation 450 of the extension 445 of a pre-grant 435.

In either or both of the pre-grant deactivation scheme 401 or the extension deactivation scheme 402, the UE 115-a may transmit a deactivation indication 460 to the network entity 105-a. In some examples, the deactivation indication 460 may be an uplink transmission status transmission (e.g., an ACK-like transmission that indicates, either explicitly or implicitly, that the UE 115-a intends to no longer utilize the pre-grant 435 or the extension 445). In some examples, the deactivation indication 460 may be a “dummy” BSR or DSR that does not include or indicate data that is to be transmitted. In some examples, the deactivation indication 460 may be an explicit request for deactivation of the pre-grant 435 or the extension 445.

In some examples, an active grant timer, an extension timer, or both, may be stopped at the UE 115-a, the network entity 105-a, or both, after or in response to communication of the deactivation indication 460. In response the network entity 105-a may utilize a remaining portion of the pre-grant 435 or the extension 445 or pre-grants 455 for communication with other UEs or for other purposes. For example, resources (e.g., time resources, frequency resources, spatial resources, or any combination thereof) corresponding to the deactivation 450 of the pre-grant deactivation scheme 401, the extension deactivation scheme 402, or both, may be reallocated (e.g., by the network entity 105-a) for use by another UE or other wireless device.

In some examples, the deactivation indication 460 may apply to one or more pre-grants 435, extensions 445, or both. For example, the deactivation 450 of the pre-grant deactivation scheme 401 may apply to the pre-grant 435 and one or more of the pre-grants 455 (e.g., and, optionally, one or more additional pre-grants subsequent in time to the pre-grant 435 or the pre-grant 455). Additionally, or alternatively, the deactivation indication 460 of the extension deactivation scheme 402 may apply to the extension 445 and one or more of the pre-grants 455 (e.g., and, optionally, one or more additional pre-grants subsequent in time to the extension 445 or the pre-grant 455). In some examples, the deactivation indication 460 may include an indication of which pre-grants, extensions or both (e.g., or a quantity of pre-grants, extensions, or both), to which the deactivation indication 460 is to apply.

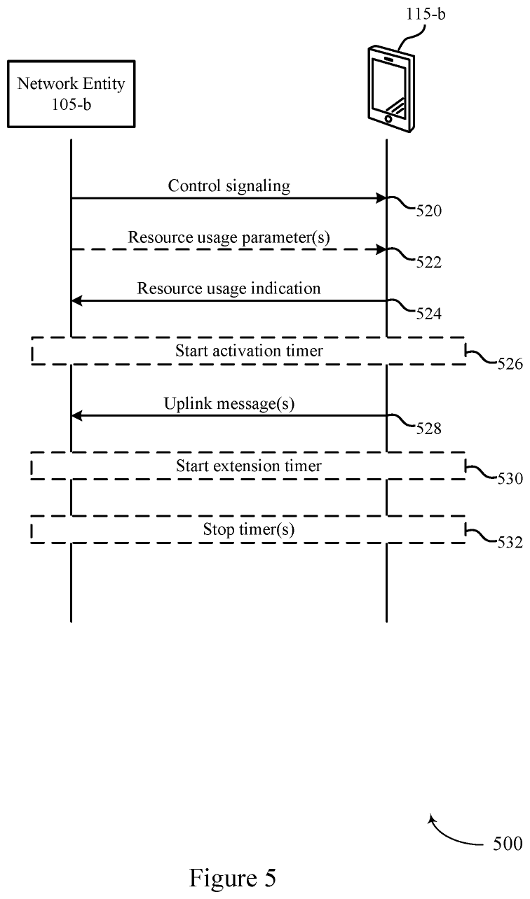

FIG. 5 shows an example of a process flow 500 that supports enhanced uplink configured grants. The process flow 500 may implement various aspects of the present disclosure described herein. The elements described in the process flow 500 (e.g., UE 115-b and network entity 105-b) may be examples of similarly named elements described herein.

In the following description of the process flow 500, the operations between the various entities or elements may be performed in different orders or at different times. Some operations may also be left out of the process flow 500, or other operations may be added. Although the various entities or elements are shown performing the operations of the process flow 500, some aspects of some operations may also be performed by other entities or elements of the process flow 500 or by entities or elements that are not depicted in the process flow, or any combination thereof.

In some examples, at 520, the UE 115-b may receive (e.g., from the network entity 105-b) control signaling (e.g., Msg 4 during the random access procedure for RRC connection, RRC configuration or reconfiguration after the random access procedure for RRC connection, or MAC CE or DCI activation after the random access procedure for RRC connection) that indicates a resource configuration that identifies a plurality of resource allocations for the UE for uplink transmission.

In some examples, at 522, the UE 115-b may receive (e.g., from the network entity 105-b) resource usage parameters (e.g., RRC configuration or reconfiguration, MAC CE activation, or DCI indication). The resource usage parameters may include an indication of a duration of the activation window, and the activation indication is transmitted based on the duration of the activation window. Additionally, or alternatively, resource usage parameters may include an indication of the extension deadline, an indication of the extension duration, or any combination thereof, and the extension indication is transmitted based on the extension deadline and/or the indication of the extension duration. In some examples, the resource usage parameters may be transmitted via, or indicated by, the control signaling at 520 (e.g., RRC configuration or reconfiguration, MAC CE activation).

In some examples, at 524, the UE 115-b may transmit (e.g., to the network entity 105-b), within a time duration corresponding to a first resource allocation of the plurality of resource allocations, a resource usage indication that indicates an intent to use the first resource allocation or to extend the first resource allocation.

In some examples, to transmit the resource usage indication, the UE 115-b may transmit (e.g., to the network entity 105-b) an activation indication within an activation window during the time duration of a first resource allocation of the plurality of resource allocations, and the activation indication indicates the intent to use the first resource allocation to transmit the one or more uplink messages. In some examples, the activation indication is an uplink transmission that may include an uplink data message, an uplink control message, an uplink signal, or any combination thereof. In some examples, the activation window may include a beginning portion of the time duration of the first resource allocation.

In some examples, to transmit the resource usage indication, the UE 115-b may transmit (e.g., to the network entity 105-b) an extension indication before an extension deadline located within the time duration of the first resource allocation of the plurality of resource allocations, and the extension indication indicates that the first resource allocation is to be extended, in accordance with an extension duration, beyond an end of the time duration of the first resource allocation. In some examples, the extension indication may include a retransmission of a transmission performed within the time duration of the first resource allocation, a buffer status report, a delay status report, a schedule request, an extension request, or any combination thereof.

In some examples, to transmit the resource usage indication, the UE 115-b may transmit (e.g., to the network entity 105-b) a deactivation indication corresponding to the plurality of resource allocations and the deactivation indication indicates that the UE intends not to use one or more second resource allocations of the plurality of resource allocations or a remaining portion of the first resource allocation after transmission of the deactivation indication. In some examples, the deactivation indication may include a transmission status indication, a buffer status report (e.g., an empty or dummy or padding buffer status report), a delay status report (e.g., an empty or dummy or padding delay status report), a deactivation request, or any combination thereof. In some examples, the remaining portion of the time duration may include an extension to the time duration.

In some examples, at 526, the UE 115-b may start, based on transmission of the activation indication and in response to an end of the activation window, an active grant timer, and the one or more uplink messages are transmitted while the active grant timer is running. The value of the active timer may be based on the time duration of a resource allocation or pre-grant. Similarly, the network entity 105-b may start, based on reception of the activation indication and in response to an end of the activation window, an active grant timer, and the one or more uplink messages are received while the active grant timer is running. In some examples, the resource allocation active state may synchronized between the UE 115-b and the network entity 105-b with the saving of latency associated with any explicit signaling exchanges (e.g., activation request and activation response) for such resource activation.

In some examples, at 528, the UE 115-b may transmit, via the first resource allocation or an extended first resource allocation, one or more uplink messages in accordance with the resource usage indication.

In some examples, at 530, the UE 115-b may start, based on transmission of the extension indication and in response to an end of the pre-grant, a grant extension timer or active grant timer extended with the extension, and the one or more uplink messages are transmitted while the grant extension timer or extended active grant timer is running. The value of the grant extension timer or the extension of active grant timer may be based on the duration of the extension. Similarly, the network entity 105-b may start, based on reception of the extension indication and in response to an end of the pre-grant, a grant extension timer or active grant timer extended with the extension, and the one or more uplink messages are received while the grant extension timer or extended active grant timer is running. In an example, the resource allocation extension state may be synchronized between the UE 115-b and the network entity 105-b with the saving of latency associated with any explicit signaling exchanges (e.g., extension request and extension response) for such extension.

In some examples, at 532, the UE 115-b may terminate, based on the transmission of deactivation indication, a running active grant timer, a running grant extension timer, or both. Similarly, the network entity 105-b may terminate, based on the reception of deactivation indication, a running active grant timer, a running grant extension timer, or both. In an example, the resource deactivation state may be synchronized between the UE 115-b and the network entity 105-b with the saving of latency associated with any explicit signaling exchanges (e.g., deactivation request and deactivation response) for such deactivation.

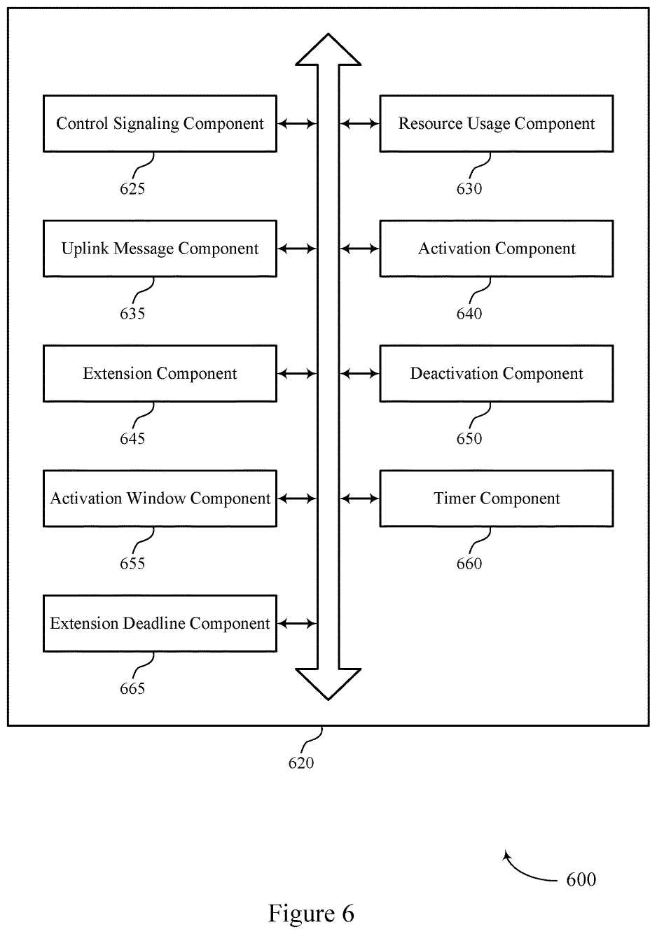

FIG. 6 shows an example 600 of a processing system 620 that supports enhanced uplink configured grants. A processing system 620 may be an example of a processing system 140 (such as of a UE 115) and may include a control signaling component 625, a resource usage component 630, an uplink message component 635, an activation component 640, an extension component 645, a deactivation component 650, an activation window component 655, a timer component 660, an extension deadline component 665, or any combination thereof. A processing system 620, or various component thereof, may be an example of means for performing (such as a means for causing a UE 115 to perform) various techniques described herein.

The control signaling component 625 may be configured to cause the UE 115 to receive control signaling that indicates a resource configuration that identifies a set of multiple resource allocations for the UE for uplink transmission. The resource usage component 630 may be configured to cause the UE 115 to transmit, within a time duration corresponding to a first resource allocation of the set of multiple resource allocations, a resource usage indication that indicates an intent to use the first resource allocation or to extend the first resource allocation. The uplink message component 635 may be configured to cause the UE 115 to transmit, via the first resource allocation or an extended first resource allocation, one or more uplink messages in accordance with the resource usage indication.

In some examples, to support transmitting the resource usage indication, the activation component 640 may be configured to cause the UE 115 to transmit an activation indication within an activation window of the time duration, where the activation indication indicates the intent to use the first resource allocation to transmit the one or more uplink messages.

In some examples, the activation indication is an uplink transmission including an uplink data message, an uplink control message, an uplink signal, or any combination thereof.

In some examples, the activation window component 655 may be configured to cause the UE 115 to receive an indication of a duration of the activation window, where the activation indication is transmitted based on the duration of the activation window.

In some examples, the timer component 660 may be configured to cause the UE 115 to start, based on transmission of the activation indication and in response to an end of the activation window, an active grant timer, where the one or more uplink messages are transmitted while the active grant timer is running.

In some examples, the activation window includes a beginning portion of the time duration of the first resource allocation.

In some examples, to support transmitting the resource usage indication, the extension component 645 may be configured to cause the UE 115 to transmit an extension indication before an extension deadline located within the time duration corresponding to the first resource allocation, where the extension indication indicates that the first resource allocation is to be extended, in accordance with an extension duration, beyond an end of the time duration of the first resource allocation.

In some examples, the extension indication includes a retransmission of a transmission performed within the time duration of the first resource allocation, a buffer status report, a delay status report, a schedule request, or any combination thereof.

In some examples, the extension deadline component 665 may be configured to cause the UE 115 to receive an indication of the extension deadline, an indication of the extension duration, or any combination thereof.

In some examples, the timer component 660 may be configured to cause the UE 115 to start, based on transmission of the extension indication, a grant extension timer, where the one or more uplink messages are transmitted while the grant extension timer is running.

In some examples, the deactivation component 650 may be configured to cause the UE 115 to transmit a deactivation indication corresponding to the set of multiple resource allocations, where the deactivation indication indicates that the UE intends not to use one or more second resource allocations of the set of multiple resource allocations or a remaining portion of the first resource allocation after transmission of the deactivation indication.

In some examples, the deactivation indication includes a transmission status indication, a buffer status report, a delay status report, a deactivation request, or any combination thereof.

In some examples, the timer component 660 may be configured to cause the UE 115 to terminate, based on the deactivation indication, a running active grant timer, a running grant extension timer, or both.

In some examples, the remaining portion of the time duration includes an extension to the time duration.

A processing system 620 may include or be a component of one or more chips, systems-on-chips (SoCs), chipsets, packages, components, or devices that individually or collectively constitute or include a processing system. A processing system 620 may interface with other components of a processing system 620. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a processing system 620).

By including or configuring a processing system 620 for operation in a processing system 620 as described herein, the processing system 620 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

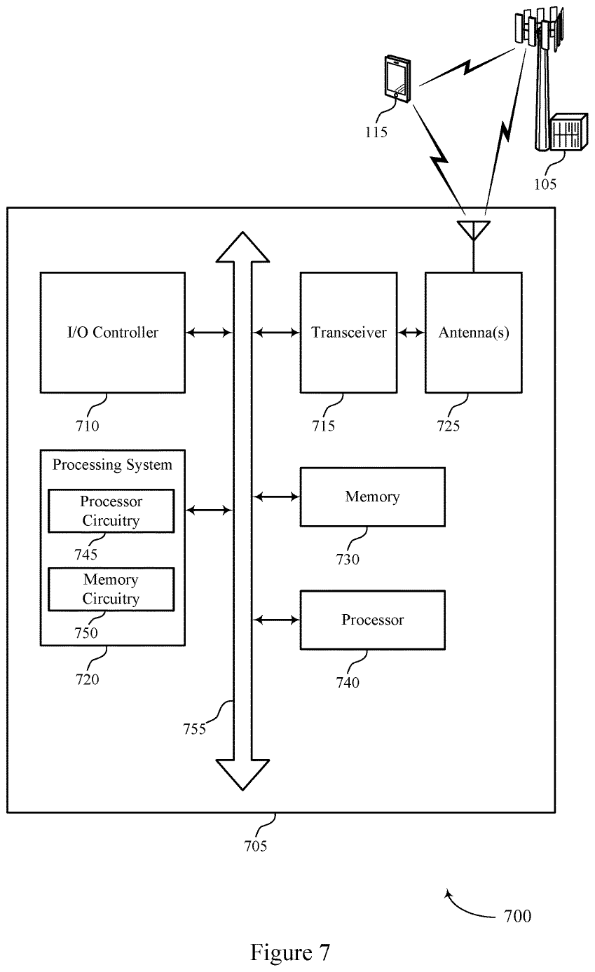

FIG. 7 shows an example of a system 700 including a device 705 that supports enhanced uplink configured grants. The device 705 may be an example of or include components of UE 115. The device 705 may communicate (such as wirelessly) with one or more other devices (such as network entities 105, UEs 115). The device 705 may include components for transmitting and receiving communication, which may include a processing system 720, an input/output (I/O) controller, such as an I/O controller 710, a transceiver 715, antenna(s) 725, a memory 730, and a processor 740. Components of the device 705 may be coupled (such as operatively, communicatively, functionally, electronically, electrically, in electronic communication) a bus 755.

The transceiver 715 may support bi-directional communication via antenna(s) 725, and may support transmission operations, reception operations, or both, as described herein. The transceiver 715 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 705). The transceiver 715 may modulate symbols and provide the modulated symbols to antenna(s) 725 for transmission, and demodulate symbols from signals received using antenna(s) 725.

The processor 740 may be a general-purpose processing component that supports various operations (such as applications) of the device 705. The memory 730 may be a general-purpose storage component that stores code executable by the processor 740. Such code may include instructions that, when executed by the processor 740, cause the device 705 to perform various functions (such as to support an application of the device 705). The I/O controller 710 may manage inputs and outputs for the device 705, may manage peripherals not integrated into the device 705, or may represent a physical connection (such as port) to an external peripheral. The processor 740 may interact with a modem, a keyboard, a mouse, a touchscreen, or other device (such as via I/O controller 710). In some implementations, a user may interact with the device 705 via the I/O controller 710 or via hardware components controlled by the I/O controller 710.

The processing system 720 may be an example of a processing system 140 or a processing system 620. For example, the processing system 720 may include processor circuitry 745 and memory circuitry 750 that stores code, and may be configured to cause the device 705 to perform operations that support enhanced uplink configured grants. Although the processing system 720 is illustrated as a separate component, which may involve a separate chip, chipset, or other module, in some implementations, one or more functions described with reference to the processing system 720 may be supported by or performed by a transceiver 715, antenna(s) 725, a processor 740, memory 730, or any combination thereof, such that a processing system 720 may include one or more of a transceiver 715, antenna(s) 725, a processor 740, memory 730, or any combination thereof.

By including or configuring the processing system 720 for operation in the device 705 as described herein, may support techniques for improved communication reliability, reduced latency, improved user experience related to reduced processing, reduced power consumption, more efficient utilization of communication resources, improved coordination between devices, longer battery life, improved utilization of processing capability, or any combination thereof.

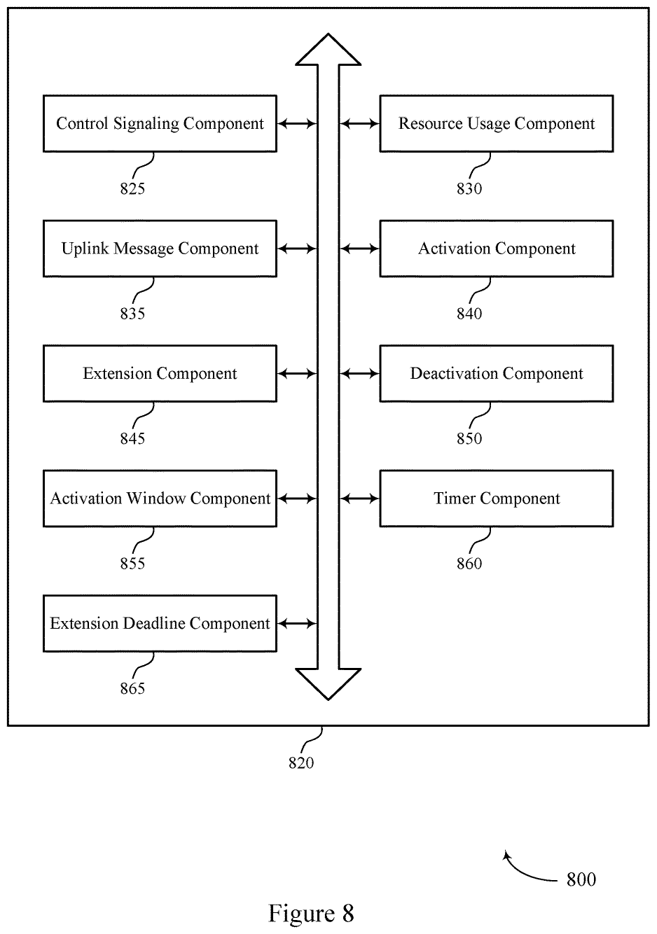

FIG. 8 shows an example 800 of a processing system 820 that supports enhanced uplink configured grants. A processing system 820 may be an example of a processing system 145 (such as network entity 105) and may include a control signaling component 825, a resource usage component 830, an uplink message component 835, an activation component 840, an extension component 845, a deactivation component 850, an activation window component 855, a timer component 860, an extension deadline component 865, or any combination thereof. A processing system 820, or various component thereof, may be an example of means for performing (such as a means for causing a network entity 105 to perform) various techniques described herein.

The control signaling component 825 may be configured to cause the network entity 105 to transmit control signaling that indicates a resource configuration that identifies a set of multiple resource allocations for a UE for uplink transmission. The resource usage component 830 may be configured to cause the network entity 105 to receive, within a time duration corresponding to a first resource allocation of the set of multiple resource allocations, a resource usage indication that indicates an intent to use the first resource allocation or to extend the first resource allocation. The uplink message component 835 may be configured to cause the network entity 105 to receive, via the first resource allocation or an extended first resource allocation, one or more uplink messages in accordance with the resource usage indication.

In some examples, to support receiving the resource usage indication, the activation component 840 may be configured to cause the network entity 105 to receive an activation indication within an activation window of the time duration, where the activation indication indicates the intent to use the first resource allocation to transmit the one or more uplink messages.

In some examples, the activation indication is an uplink transmission including an uplink data message or uplink control message, an uplink signal, or any combination thereof.

In some examples, the activation window component 855 may be configured to cause the network entity 105 to transmit an indication of a duration of the activation window, where the activation indication is received based on the duration of the activation window.

In some examples, the timer component 860 may be configured to cause the network entity 105 to start, based on reception of the activation indication and in response to an end of the activation window, an active grant timer, where the one or more uplink messages are received while the active grant timer is running.

In some examples, the activation window includes a beginning portion of the time duration of the first resource allocation.

In some examples, to support receiving the resource usage indication, the extension component 845 may be configured to cause the network entity 105 to receive an extension indication before an extension deadline located within the time duration corresponding to the first resource allocation, where the extension indication indicates that the first resource allocation is to be extended, in accordance with an extension duration, beyond an end of the time duration of the first resource allocation.

In some examples, the extension indication includes a retransmission of a transmission performed within the time duration of the first resource allocation, a buffer status report, a delay status report, a schedule request, or any combination thereof.

In some examples, the extension deadline component 865 may be configured to cause the network entity 105 to transmit an indication of the extension deadline, an indication of the extension duration, or any combination thereof.

In some examples, the timer component 860 may be configured to cause the network entity 105 to start, based on reception of the extension indication, a grant extension timer, where the one or more uplink messages are received while the grant extension timer is running.

In some examples, the deactivation component 850 may be configured to cause the network entity 105 to receive a deactivation indication corresponding to the set of multiple resource allocations, where the deactivation indication indicates that the UE intends not to use one or more second resource allocations of the set of multiple resource allocations or a remaining portion of the first resource allocation after transmission of the deactivation indication.

In some examples, the deactivation indication includes a transmission status indication, a buffer status report, a delay status report, a deactivation request, or any combination thereof.

In some examples, the timer component 860 may be configured to cause the network entity 105 to terminate, based on the deactivation indication, a running active grant timer, a running grant extension timer, or both.

In some examples, the remaining portion of the time duration includes an extension to the time duration.

A processing system 820 may include or be an example of one or more chips, SoCs, chipsets, packages, components, or devices that individually or collectively constitute or include a processing system. A processing system 820 may interface with other components of a network entity 105. For example, operations described with reference to a processing system 820, or various components thereof, may be performed by or with other such components, including a receiver, a transmitter, a transceiver, a modem, a user interface, a modulator/demodulator, an encoder/decoder, or any combination thereof (such as of the processing system 820, coupled with the processing system 820, of a network entity 105). Operations described herein with reference to the processing system 820, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 820 for operation in a processing system 820 as described herein, the processing system 820 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

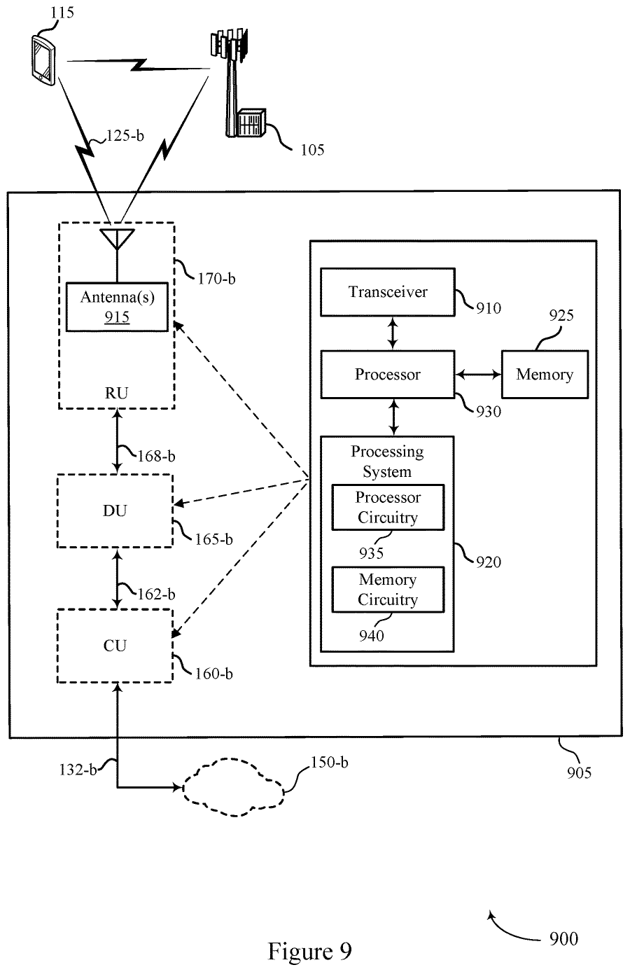

FIG. 9 shows an example of a system 900 including a device 905 that supports enhanced uplink configured grants. The device 905 may communicate (such as via one or more wired interfaces or one or more wireless interfaces) with other network devices or network equipment such as a core network 150-b, other network entities 105, UEs 115, or any combination thereof. The device 905 may include components for transmitting and receiving communication, which may include a processing system 920, a transceiver 910, antenna(s) 915, a memory 925, and a processor 930. Components of the device 905 may be coupled (such as operatively, communicatively, functionally, electronically, electrically, in electronic communication) via one or more interfaces.

The transceiver 910 may communicate bi-directionally with another transceiver via wired or wireless links, and may support transmission operations, reception operations, or both, as described herein. The transceiver 910 may include a modem to modulate and demodulate signals, to provide the modulated signals for transmission (such as via antenna(s) 915, via a wired interface), and to demodulate received signals (such as received via antenna(s) 915, received via a wired interface). The transceiver 910 may be operable to support communication via one or more communication links (such as a communication link 125-b, a backhaul link 132-b, a midhaul link 162-b, fronthaul link 168-b).

The processor 930 may be a general-purpose processing component that supports various operations (such as applications) of the device 905. The memory 925 may be a general-purpose storage component that stores code executable by the processor 930. Such code may include instructions that, when executed by the processor 930, cause the device 905 to perform various functions (such as to support an application of the device 905).

For examples in which the device 905 is a network entity 105 in a disaggregated architecture, one or more components of the device 905 may be located at one or more of a CU 160-b, a DU 165-b, or an RU 170-b, one or more of which may include aspects of the processing system 920, the processor 930, the memory 925, or the transceiver 910. Functions of the device 905 may be performed at different components or an operation may be divided between different components (such as different functions being supported by aspects of the CU 160-b, the DU 165-b, or the RU 170-b, the transceiver 910, the processor 930, the memory 925, the processing system 920, or any combination thereof). For example, the processing system 920 may be a component of one or more of the CU 160-b, the DU 165-b, or the RU 170-b. In some examples, interfaces between components of device 905 (such as CU 160-b, DU 165-b, RU 170-b) may support communication at a protocol layer or between protocol layers of a protocol stack.

In some examples, the processing system 920 may manage aspects of communication with the core network 150-b (such as via a backhaul link 132). For example, the processing system 920 may manage the transfer of data communication for UEs 115 with a gateway of the core network 150-b. In some examples, the processing system 920 may manage communication with one or more other network entities 105 and may include a controller or scheduler for controlling communication with UEs 115 (such as in cooperation with the one or more other network entities 105). In some examples, the processing system 920 may support an interface (such as X2 interface, Xn interface) to provide communication between network entities 105.

The processing system 920 may be an example of a processing system 145 or a processing system 820. For example, the processing system 920 may include processor circuitry 935 and memory circuitry 940 that stores code, and the processing system 920 may be configured to cause the device 905 to perform operations that support enhanced uplink configured grants. Although the processing system 920 is illustrated as a separate component, which may involve a separate chip, chipset, or other module, in some implementations, one or more functions described with reference to the processing system 920 may be supported by or performed by a transceiver 910, antenna(s) 915, a processor 930, memory 925, or any combination thereof, such that a processing system 920 may include one or more of a transceiver 910, antenna(s) 915, a processor 930, memory 925, or any combination thereof. Further, processor circuitry 935 and memory circuitry 940 each may be implemented at the device 905 in accordance with an aggregated architecture, or the processor circuitry 935 and the memory circuitry 940 may be implemented at one or more of a CU 160-b, a DU 165-b, or an RU 170-b in accordance with a disaggregated architecture.

By including or configuring the processing system 920 for operation in the device 905 as described herein, may support techniques for improved communication reliability, reduced latency, improved user experience related to reduced processing, reduced power consumption, more efficient utilization of communication resources, improved coordination between devices, longer battery life, improved utilization of processing capability, or any combination thereof.

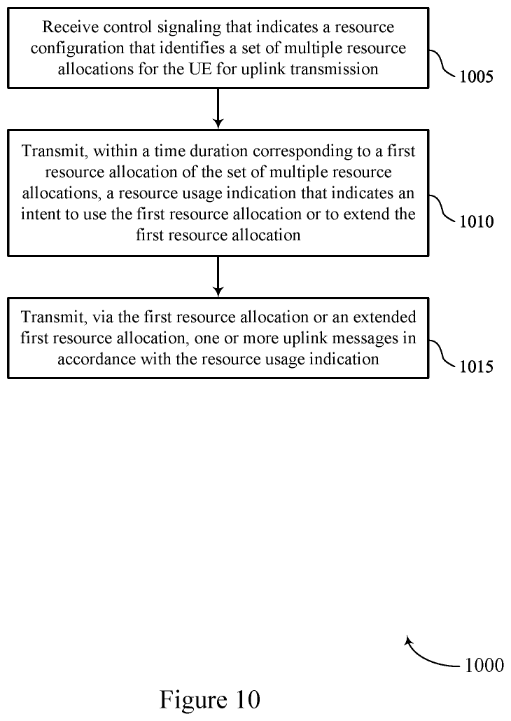

FIG. 10 shows an example of a method 1000 that supports enhanced uplink configured grants. Operations of the method 1000 may be performed by a UE or its components (such as using a processing system configured to cause the UE 115 to perform one or more of the operations) as described herein.

At 1005, the method may include receiving control signaling that indicates a resource configuration that identifies a set of multiple resource allocations for the UE for uplink transmission. In some examples, aspects of the operations of 1005 may be performed by a control signaling component 625.

At 1010, the method may include transmitting, within a time duration corresponding to a first resource allocation of the set of multiple resource allocations, a resource usage indication that indicates an intent to use the first resource allocation or to extend the first resource allocation. In some examples, aspects of the operations of 1010 may be performed by a resource usage component 630.

At 1015, the method may include transmitting, via the first resource allocation or an extended first resource allocation, one or more uplink messages in accordance with the resource usage indication. In some examples, aspects of the operations of 1015 may be performed by an uplink message component 635.

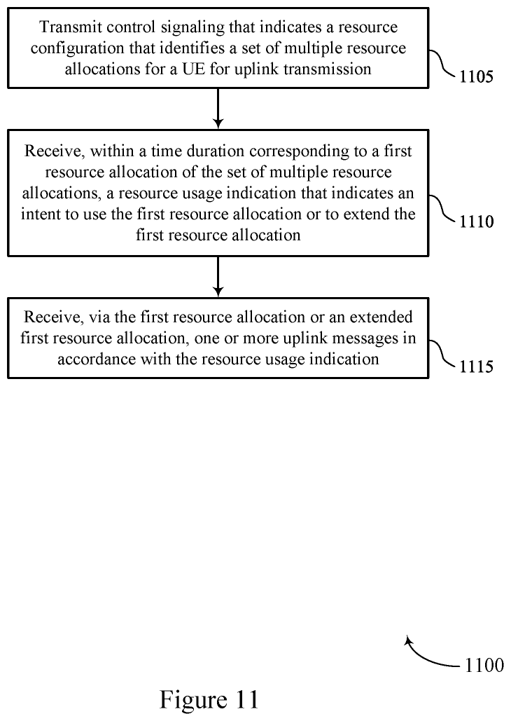

FIG. 11 shows an example of a method 1100 that supports enhanced uplink configured grants. Operations of the method 1100 may be performed by a network entity 105 or its components (such as using a processing system configured to cause the network entity to perform one or more operations) as described herein.

At 1105, the method may include transmitting control signaling that indicates a resource configuration that identifies a set of multiple resource allocations for a UE for uplink transmission. In some examples, aspects of the operations of 1105 may be performed by a control signaling component 825.

At 1110, the method may include receiving, within a time duration corresponding to a first resource allocation of the set of multiple resource allocations, a resource usage indication that indicates an intent to use the first resource allocation or to extend the first resource allocation. In some examples, aspects of the operations of 1110 may be performed by a resource usage component 830.

At 1115, the method may include receiving, via the first resource allocation or an extended first resource allocation, one or more uplink messages in accordance with the resource usage indication. In some examples, aspects of the operations of 1115 may be performed by an uplink message component 835.

Implementation examples are described in the following numbered clauses:
Aspect 1: A method for wireless communications at a UE, comprising: receiving control signaling that indicates a resource configuration that identifies a plurality of resource allocations for the UE for uplink transmission; transmitting, within a time duration corresponding to a first resource allocation of the plurality of resource allocations, a resource usage indication that indicates an intent to use the first resource allocation or to extend the first resource allocation; and transmitting, via the first resource allocation or an extended first resource allocation, one or more uplink messages in accordance with the resource usage indication.
Aspect 2: The method of aspect 1, wherein transmitting the resource usage indication comprises: transmitting an activation indication within an activation window of the time duration, wherein the activation indication indicates the intent to use the first resource allocation to transmit the one or more uplink messages.
Aspect 3: The method of aspect 2, wherein the activation indication is an uplink transmission comprising an uplink data message, an uplink control message, an uplink signal, or any combination thereof.
Aspect 4: The method of any of aspects 2 through 3, further comprising: receiving an indication of a duration of the activation window, wherein the activation indication is transmitted based at least in part on the duration of the activation window.
Aspect 5: The method of any of aspects 2 through 4, further comprising: starting, based at least in part on transmission of the activation indication and in response to an end of the activation window, an active grant timer, wherein the one or more uplink messages are transmitted while the active grant timer is running.
Aspect 6: The method of any of aspects 2 through 5, wherein the activation window comprises a beginning portion of the time duration of the first resource allocation.
Aspect 7: The method of any of aspects 1 through 6, wherein transmitting the resource usage indication comprises: transmitting an extension indication before an extension deadline located within the time duration corresponding to the first resource allocation, wherein the extension indication indicates that the first resource allocation is to be extended, in accordance with an extension duration, beyond an end of the time duration of the first resource allocation.
Aspect 8: The method of aspect 7, wherein the extension indication comprises a retransmission of a transmission performed within the time duration of the first resource allocation, a buffer status report, a delay status report, a schedule request, or any combination thereof.
Aspect 9: The method of any of aspects 7 through 8, further comprising: receiving an indication of the extension deadline, an indication of the extension duration, or any combination thereof.
Aspect 10: The method of any of aspects 7 through 9, further comprising: starting, based at least in part on transmission of the extension indication, a grant extension timer, wherein the one or more uplink messages are transmitted while the grant extension timer is running.
Aspect 11: The method of any of aspects 1 through 10, further comprising: transmitting a deactivation indication corresponding to the plurality of resource allocations, wherein the deactivation indication indicates that the UE intends not to use one or more second resource allocations of the plurality of resource allocations or a remaining portion of the first resource allocation after transmission of the deactivation indication.
Aspect 12: The method of aspect 11, wherein the deactivation indication comprises a transmission status indication, a buffer status report, a delay status report, a deactivation request, or any combination thereof.
Aspect 13: The method of any of aspects 11 through 12, further comprising: terminating, based at least in part on the deactivation indication, a running active grant timer, a running grant extension timer, or both.
Aspect 14: The method of any of aspects 11 through 13, wherein the remaining portion of the time duration comprises an extension to the time duration.
Aspect 15: A method for wireless communications at a network entity, comprising: transmitting control signaling that indicates a resource configuration that identifies a plurality of resource allocations for a UE for uplink transmission; receiving, within a time duration corresponding to a first resource allocation of the plurality of resource allocations, a resource usage indication that indicates an intent to use the first resource allocation or to extend the first resource allocation; and receiving, via the first resource allocation or an extended first resource allocation, one or more uplink messages in accordance with the resource usage indication.
Aspect 16: The method of aspect 15, wherein receiving the resource usage indication comprises: receiving an activation indication within an activation window of the time duration, wherein the activation indication indicates the intent to use the first resource allocation to transmit the one or more uplink messages.
Aspect 17: The method of aspect 16, wherein the activation indication is an uplink transmission comprising an uplink data message or uplink control message, an uplink signal, or any combination thereof.
Aspect 18: The method of any of aspects 16 through 17, further comprising: transmitting an indication of a duration of the activation window, wherein the activation indication is received based at least in part on the duration of the activation window
Aspect 19: The method of any of aspects 16 through 18, further comprising: starting, based at least in part on reception of the activation indication and in response to an end of the activation window, an active grant timer, wherein the one or more uplink messages are received while the active grant timer is running.
Aspect 20: The method of any of aspects 16 through 19, wherein the activation window comprises a beginning portion of the time duration of the first resource allocation.
Aspect 21: The method of any of aspects 15 through 20, wherein receiving the resource usage indication comprises: receiving an extension indication before an extension deadline located within the time duration corresponding to the first resource allocation, wherein the extension indication indicates that the first resource allocation is to be extended, in accordance with an extension duration, beyond an end of the time duration of the first resource allocation.
Aspect 22: The method of aspect 21, wherein the extension indication comprises a retransmission of a transmission performed within the time duration of the first resource allocation, a buffer status report, a delay status report, a schedule request, or any combination thereof.
Aspect 23: The method of any of aspects 21 through 22, further comprising: transmitting an indication of the extension deadline, an indication of the extension duration, or any combination thereof.
Aspect 24: The method of any of aspects 21 through 23, further comprising: starting, based at least in part on reception of the extension indication, a grant extension timer, wherein the one or more uplink messages are received while the grant extension timer is running.
Aspect 25: The method of any of aspects 15 through 24, further comprising: receiving a deactivation indication corresponding to the plurality of resource allocations, wherein the deactivation indication indicates that the UE intends not to use one or more second resource allocations of the plurality of resource allocations or a remaining portion of the first resource allocation after transmission of the deactivation indication.
Aspect 26: The method of aspect 25, wherein the deactivation indication comprises a transmission status indication, a buffer status report, a delay status report, a deactivation request, or any combination thereof.
Aspect 27: The method of any of aspects 25 through 26, further comprising: terminating, based at least in part on the deactivation indication, a running active grant timer, a running grant extension timer, or both.
Aspect 28: The method of any of aspects 25 through 27, wherein the remaining portion of the time duration comprises an extension to the time duration.
Aspect 29: A UE for wireless communications, comprising a processing system that includes processor circuitry and memory circuitry that stores code, the processing system configured to cause the UE to perform a method of any of aspects 1 through 14.
Aspect 30: A UE for wireless communications, comprising at least one means for performing a method of any of aspects 1 through 14.
Aspect 31: A non-transitory computer-readable medium storing code for wireless communications, the code comprising instructions executable by one or more processors to perform a method of any of aspects 1 through 14.
Aspect 32: A network entity for wireless communications, comprising a processing system that includes processor circuitry and memory circuitry that stores code, the processing system configured to cause the network entity to perform a method of any of aspects 15 through 28.
Aspect 33: A network entity for wireless communications, comprising at least one means for performing a method of any of aspects 15 through 28.
Aspect 34: A non-transitory computer-readable medium storing code for wireless communications, the code comprising instructions executable by one or more processors to perform a method of any of aspects 15 through 28.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling that indicates a resource configuration that identifies a plurality of resource allocations for the UE for uplink transmission;
transmit, within a time duration corresponding to a first resource allocation of the plurality of resource allocations, a resource usage indication that indicates an intent to use the first resource allocation or to extend the first resource allocation; and
transmit, via the first resource allocation or an extended first resource allocation, one or more uplink messages in accordance with the resource usage indication.

2. The UE of claim 1, wherein, to transmit the resource usage indication, the one or more processors are individually or collectively operable to execute the code to cause the UE to:
transmit an activation indication within an activation window of the time duration, wherein the activation indication indicates the intent to use the first resource allocation to transmit the one or more uplink messages.

3. The UE of claim 2, wherein the activation indication is an uplink transmission comprising an uplink data message, an uplink control message, an uplink signal, or any combination thereof.

4. The UE of claim 2, wherein the one or more processors are individually or collectively further operable to execute the code to cause the UE to:
receive an indication of a duration of the activation window, wherein the activation indication is transmitted based at least in part on the duration of the activation window.

5. The UE of claim 2, wherein the one or more processors are individually or collectively further operable to execute the code to cause the UE to:
start, based at least in part on transmission of the activation indication and in response to an end of the activation window, an active grant timer, wherein the one or more uplink messages are transmitted while the active grant timer is running.

6. The UE of claim 2, wherein the activation window comprises a beginning portion of the time duration corresponding to the first resource allocation.

7. The UE of claim 1, wherein, to transmit the resource usage indication, the one or more processors are individually or collectively operable to execute the code to cause the UE to:
transmit an extension indication before an extension deadline located within the time duration corresponding to the first resource allocation, wherein the extension indication indicates that the first resource allocation is to be extended, in accordance with an extension duration, beyond an end of the time duration corresponding to the first resource allocation.

8. The UE of claim 7, wherein the extension indication comprises a retransmission of a transmission performed within the time duration corresponding to the first resource allocation, a buffer status report, a delay status report, a schedule request, or any combination thereof.

9. The UE of claim 7, wherein the one or more processors are individually or collectively further operable to execute the code to cause the UE to:
receive an indication of the extension deadline, an indication of the extension duration, or any combination thereof.

10. The UE of claim 7, wherein the one or more processors are individually or collectively further operable to execute the code to cause the UE to:
start, based at least in part on transmission of the extension indication, a grant extension timer, wherein the one or more uplink messages are transmitted while the grant extension timer is running.

11. The UE of claim 1, wherein the one or more processors are individually or collectively further operable to execute the code to cause the UE to:
transmit a deactivation indication corresponding to the plurality of resource allocations, wherein the deactivation indication indicates that the UE intends not to use one or more second resource allocations of the plurality of resource allocations or a remaining portion of the first resource allocation after transmission of the deactivation indication.

12. The UE of claim 11, wherein the deactivation indication comprises a transmission status indication, a buffer status report, a delay status report, a deactivation request, or any combination thereof.

13. The UE of claim 11, wherein the one or more processors are individually or collectively further operable to execute the code to cause the UE to:
terminate, based at least in part on the deactivation indication, a running active grant timer, a running grant extension timer, or both.

14. The UE of claim 11, wherein the remaining portion of the time duration comprises an extension to the time duration.

15. A network entity, comprising:
one or more memories storing processor-executable code; and
one or more processors coupled with the one or more memories and individually or collectively operable to execute the code to cause the network entity to:
transmit control signaling that indicates a resource configuration that identifies a plurality of resource allocations for a user equipment (UE) for uplink transmission;
receive, within a time duration corresponding to a first resource allocation of the plurality of resource allocations, a resource usage indication that indicates an intent to use the first resource allocation or to extend the first resource allocation; and
receive, via the first resource allocation or an extended first resource allocation, one or more uplink messages in accordance with the resource usage indication.

16. The network entity of claim 15, wherein, to receive the resource usage indication, the one or more processors are individually or collectively operable to execute the code to cause the network entity to:
receive an activation indication within an activation window of the time duration, wherein the activation indication indicates the intent to use the first resource allocation to transmit the one or more uplink messages.

17. The network entity of claim 16, wherein the activation indication is an uplink transmission comprising an uplink data message or uplink control message, an uplink signal, or any combination thereof.

18. The network entity of claim 16, wherein the one or more processors are individually or collectively further operable to execute the code to cause the network entity to:
transmit an indication of a duration of the activation window, wherein the activation indication is received based at least in part on the duration of the activation window.

19. The network entity of claim 16, wherein the one or more processors are individually or collectively further operable to execute the code to cause the network entity to:
start, based at least in part on reception of the activation indication and in response to an end of the activation window, an active grant timer, wherein the one or more uplink messages are received while the active grant timer is running.

20. A method for wireless communications at a user equipment (UE), comprising:
receiving control signaling that indicates a resource configuration that identifies a plurality of resource allocations for the UE for uplink transmission;
transmitting, within a time duration corresponding to a first resource allocation of the plurality of resource allocations, a resource usage indication that indicates an intent to use the first resource allocation or to extend the first resource allocation; and
transmitting, via the first resource allocation or an extended first resource allocation, one or more uplink messages in accordance with the resource usage indication.
